(19) United States
(12) Patent Application Publication
(10) Pub. No.: US 2014/0026725 A1
(43) Pub. Date: Jan. 30, 2014

(54) UNIVERSAL EDGE GUIDE

(71) Applicant: Dino Makropoulos, Edison, NJ (US)

(72) Inventor: Dino Makropoulos, Edison, NJ (US)

(21) Appl. No.: 13/877,134

(22) PCT Filed: Sep. 29, 2011
(86) PCT No.: PCT/US11/54097

§ 371 Date: Sep. 25, 2013

Related U.S. Application Data
(60) Provisional application No. 61/387,966, filed on Sep. 29, 2010.

(51) Int. Cl. B23D 47/02

(52) U.S. Cl. CPC B23D 47/02
USPC 83/13; 83/743

(57) ABSTRACT

A universal edge guide is provided that is operable for guiding a tool with respect to an edge of a workpiece. In accordance with an embodiment, the universal edge guide provides tool guidance by way of a sliding fence abutting an edge of the workpiece well before the initial engagement of the tool working portion with the workpiece, during the engagement of the tool working portion with the workpiece, and after the disengagement of the tool working portion with the workpiece.

### FIELD

The present invention is related generally to the field of workpiece cutting. More particularly, the present invention involves systems and methods that enable accurate cutting of a workpiece and for the guiding of cutting/milling tools.

### BRIEF DESCRIPTION OF THE DRAWINGS

Embodiments are illustrated by way of example and not by way of limitation in the figures of the accompanying drawings, in which like references may indicate similar elements throughout the various figures unless otherwise specified.

FIGS. 1A-B are top and bottom perspective views, respectively, of a universal sliding edge guide, in accordance with an embodiment;

FIG. 1C is a top perspective view of the universal sliding edge guide wherein the fence has been slidingly positioned on the support beam, in accordance with the embodiment of FIG. 1A;

FIG. 1D is a top perspective view of the universal sliding edge guide wherein the fence has been positioned such that the fence first end extends away from the support beam first end and the fence second end is adjacent the support beam second end, in accordance with the embodiment of FIG. 1A;

FIGS. 2A-2C are top perspective views of the universal sliding edge guide showing an embodiment of a method of cutting a workpiece using a circular saw coupled to the tool plate, showing the operation of the sliding fence;

FIG. 3 is a bottom perspective view of the tool plate assembly in accordance with an embodiment;

FIGS. 4A-4B top and bottom perspective views, respectively, of the universal sliding edge guide in accordance with the embodiment of FIG. 1A;

FIGS. 5A-5B are top and bottom perspective views, respectively, of the universal sliding edge guide in accordance with the embodiment of FIG. 1A;

FIGS. 6A-B are front and side perspective views, respectively, of the corner of the universal sliding edge guide, in accordance with an embodiment;

FIG. 7 is a perspective view of an embodiment of the extension arm sliding support and the lateral extension arm;

FIG. 8 is a bottom perspective view of a tool plate assembly in accordance with another embodiment;

FIG. 9 is a track guide tool plate:

FIGS. 10A-E are top, bottom, exploded, and assembled with a circular saw perspective views and a front view, respectively, of a universal edge guide in accordance with an embodiment; and

FIG. 11 is a bottom perspective view of an embodiment of a pusher bar assembly as provided on the embodiment of the universal edge guide of FIG. 10A.

### DETAILED DESCRIPTION

In the following description, embodiments of apparatus and methods will be disclosed. For purposes of explanation, specific numbers, materials, and/or configurations are set forth in order to provide a thorough understanding of the embodiments. However, it will also be apparent to those skilled in the art that the embodiments may be practiced without one or more of the specific details, or with other approaches, materials, components, etc. In other instances, well-known structures, materials, and/or operations are not shown and/or described in detail to avoid obscuring the embodiments. Accordingly, in some instances, features are omitted and/or simplified in order to not obscure the disclosed embodiments. Furthermore, it is understood that the embodiments shown in the figures are illustrative representations and are not necessarily drawn to scale.

Reference throughout this specification to “one embodiment” or “an embodiment” means that a particular feature, structure, or characteristic described in connection with the embodiment is included in at least one embodiment of claimed subject matter. Thus, the appearances of the phrase “in one embodiment” or “an embodiment” in various places throughout this specification are not necessarily all referring to the same embodiment. Furthermore, the particular features, structures, or characteristics may be combined in one or more embodiments.

Reference will now be made to embodiments illustrated in the drawings and specific language which will be used to describe the same. It will nevertheless be understood that no limitation of the scope of the invention is thereby intended. Alterations and further modifications of the illustrated embodiments and further applications of the principles of the invention, as would normally occur to one skilled in the art to which the invention relates, are also within the scope of the invention.

The present invention is a universal sliding edge guide operable for guiding interchangeable handheld power tools, hand tools, marking and scribing instruments, among other instruments (referred herein as “tools” for simplicity), with respect to an edge of a workpiece. One embodiment of the present invention provides tool guidance by way of a sliding fence abutting an edge of the workpiece well before the initial engagement of the tool working portion, such as, but not limited to, a saw blade, with the workpiece, during the engagement of the tool working portion with the workpiece, and after the disengagement of the tool working portion with the workpiece. The sliding fence slides relative to the tool so as to engage the workpiece before the tool working portion does. The embodiment of the universal sliding edge guide provides added control of the tool at the beginning and the end of the tool working portion engagement with the workpiece as compared with current edge guides. The telescoping feature allows for providing a shorter, more compact edge guide for ease of handling and transportation, among others, as compared with a stationary edge guide having similar features. By way of example, it is well known how unbalanced a circular saw base plate or a T-square is at the beginning and end of the workpiece, where the tool may rotate out of the intended direction. Embodiments in accordance with the present invention solve this unbalanced, uncontrolled condition as well as provide support through the entire workpiece operation.

Another embodiment of the present invention provides a fence that is stationary with respect to the tool but provides an extended forward region and an extended rearward region. The extended forward region is operable such that the fence abuts an edge of the workpiece well before the initial engagement of the tool working portion with the workpiece. The extended reward region is operable such that the fence abuts an edge of the workpiece well after the disengagement of the tool working portion with the workpiece. This embodiment provides added control of the tool at the beginning and the end of the tool engagement with the workpiece as compared with current edge guides.

Embodiments presented herein are described and illustrated in the figures in combination with a circular saw by way of example and to show functionality of the embodiments. It is understood that reference to a circular saw is only for convenience and that no limitation is implied as to what tool may be used with the embodiments. Other tools that may be used in combination with embodiments presented herein include, but are not limited to, jig saw, router, belt sander, planer, cut-off saw, grinder, drill, sliding square, sliding level, tile layout guide and the like.

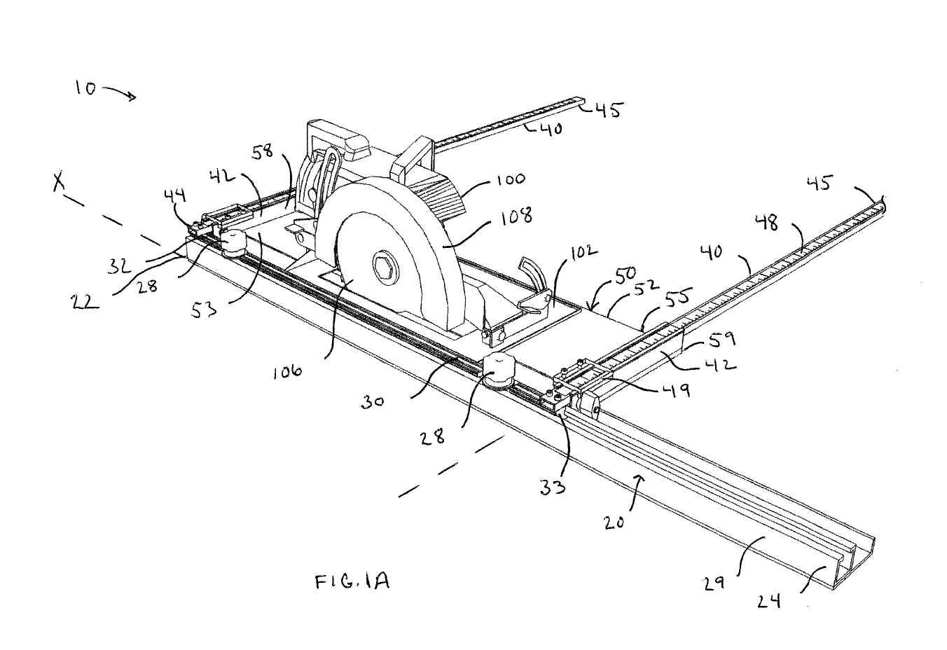

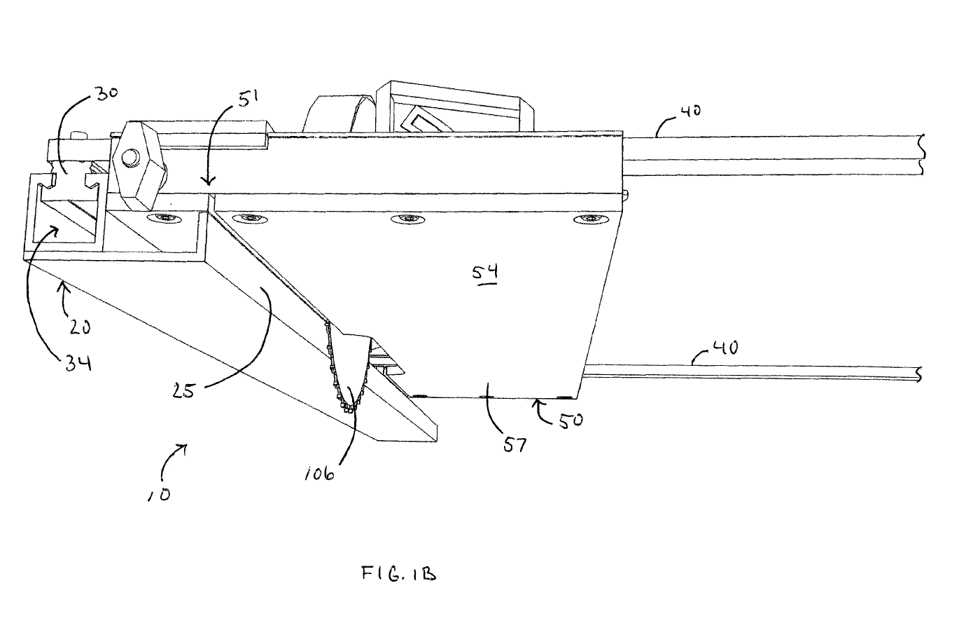

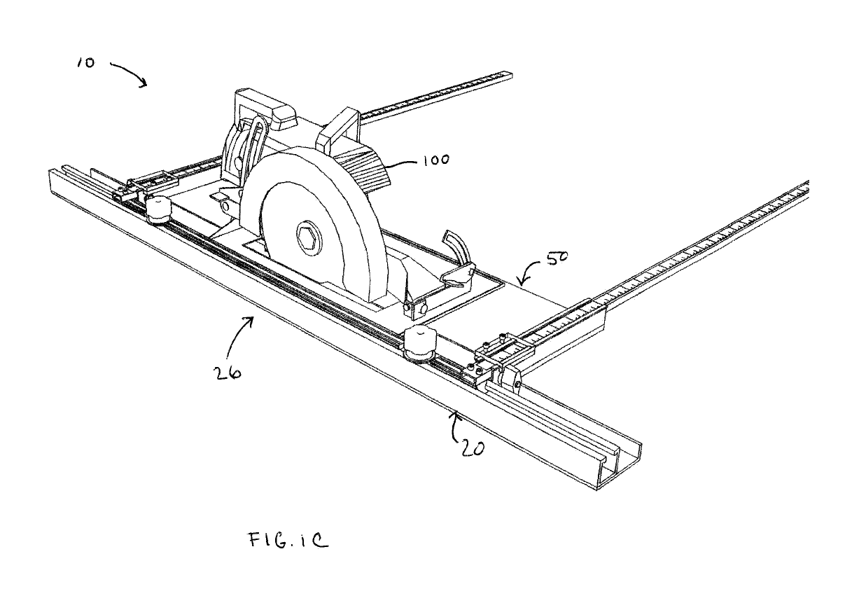

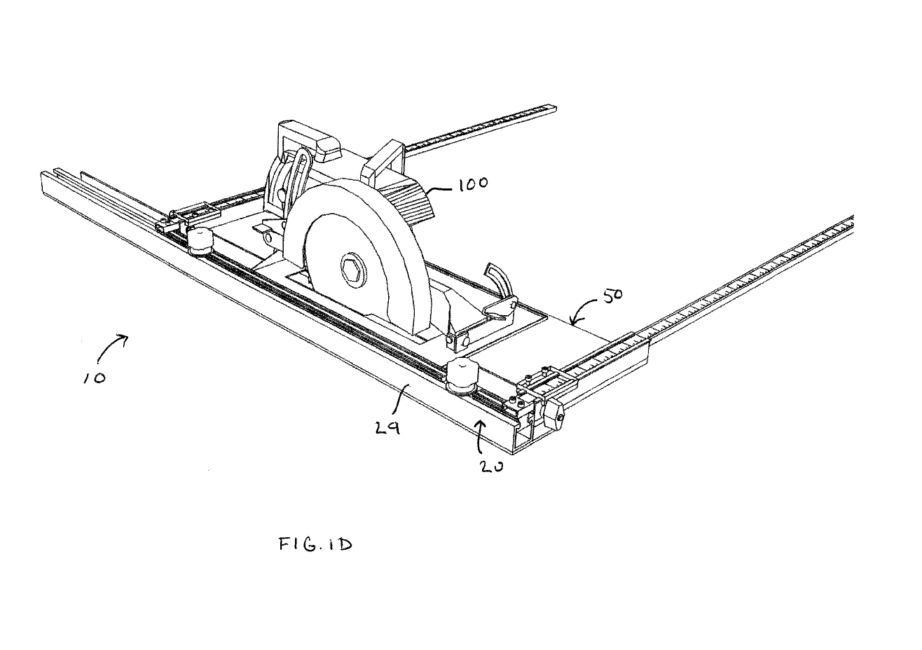

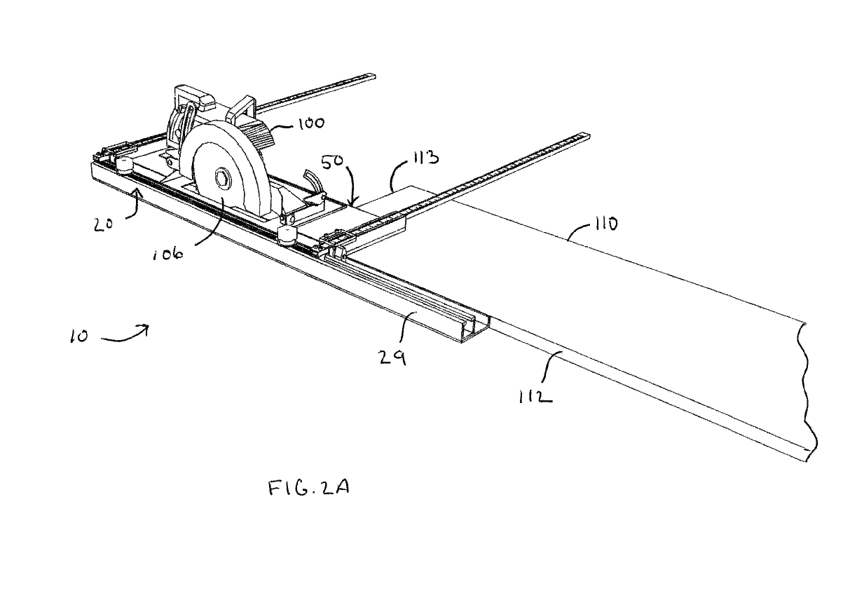

FIGS. 1A-B are top and bottom perspective views, respectively, of a universal sliding edge guide 10 in accordance with an embodiment. The universal sliding edge guide 10 comprises a tool plate assembly 50, a pair of lateral extension arms 40, and a sliding fence assembly 20. The sliding fence assembly 20 comprises a support beam 30 and a fence 29 coupled in sliding engagement, operable such that the fence 29 may slide along a significant portion of the length of the support beam 30.

The tool plate assembly 50 is an elongated member comprising a tool plate assembly first end 58 and a tool plate assembly second end 59 opposite the tool plate assembly first end 58. The tool plate assembly 50 defines a longitudinal axis X. The tool plate assembly 50 is operable to couple to and support a tool, such as a circular saw 100, by way of example, but not limited thereto, such that a saw blade 106 may be positioned to cut parallel to the longitudinal axis X.

The tool plate assembly 50 comprises a tool plate 52 and a pair of extension arm sliding supports 42. The tool plate 52 comprises a tool plate first end 53 and a tool plate second end 55 opposite the tool plate first end 53. The tool plate 52 is operable for coupling to a tool base plate 102 of the circular saw 100. In accordance with an embodiment, a tool base plate 102 is coupled to the tool plate 52. The coupling of the tool base plate 102 may be, for example, by way of adhesive and mechanical fasteners, among others.

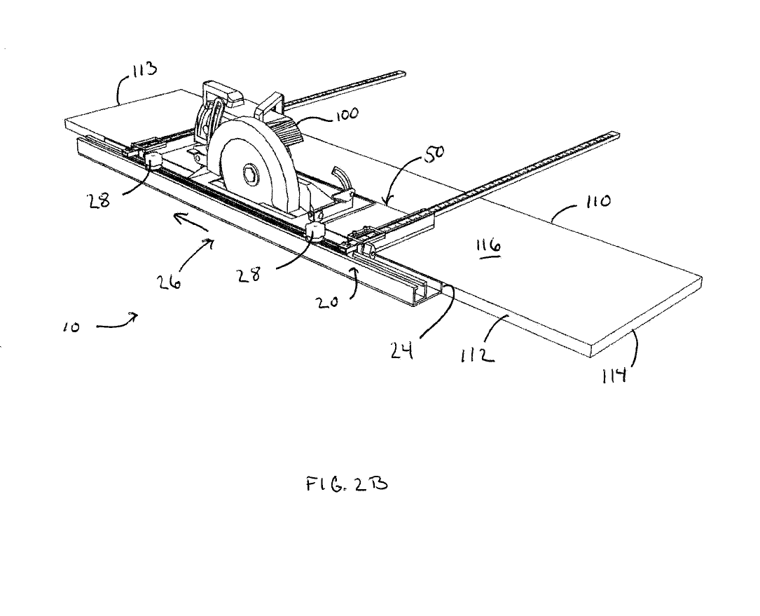

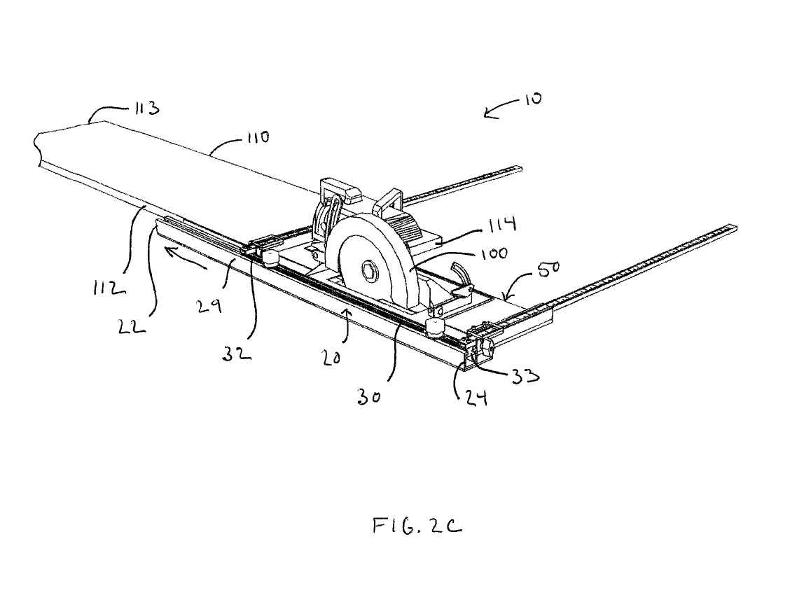

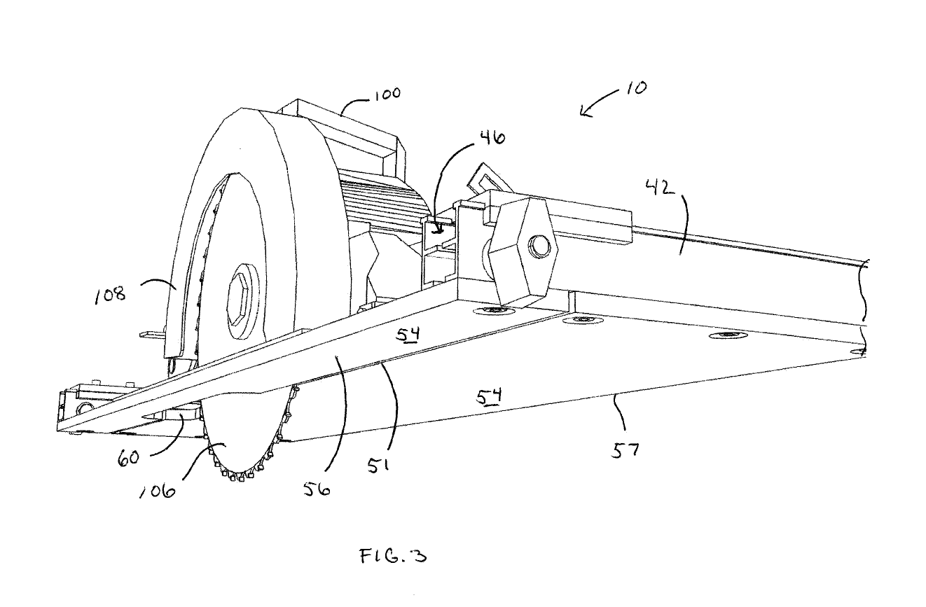

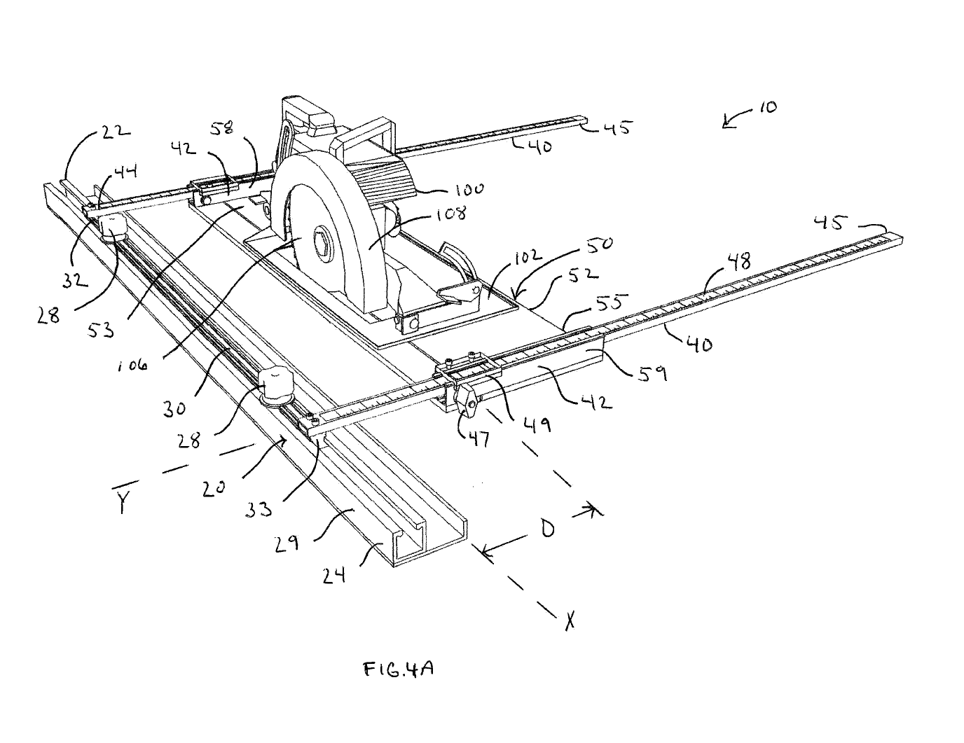

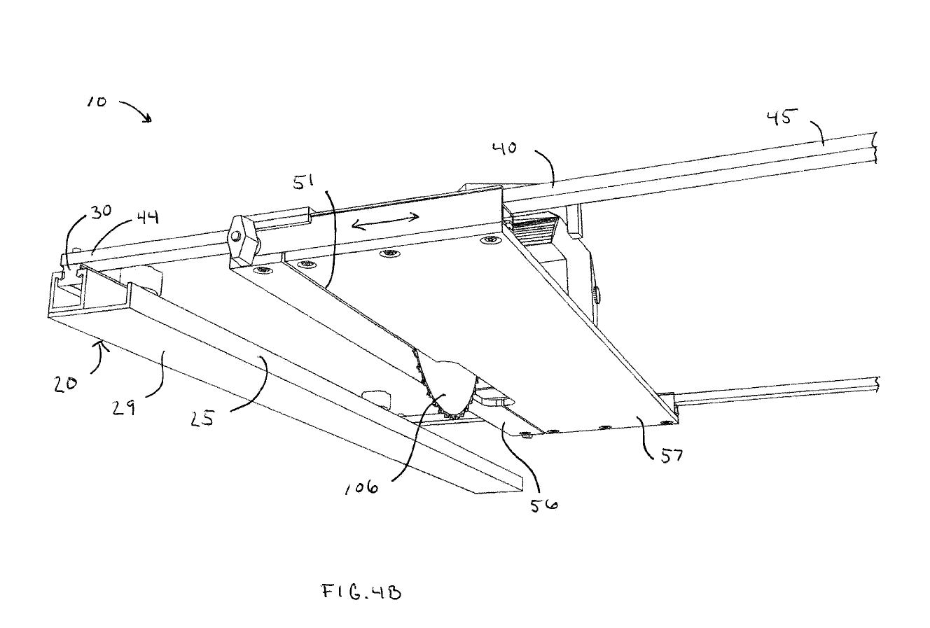

The tool plate 52 is operable to accommodate the working portion of the power tool therethrough, in this embodiment, the saw blade 106. FIG. 1B is a bottom perspective view of the tool plate assembly 50 in accordance with an embodiment. FIG. 3 is a bottom perspective view of the tool plate assembly 50 in accordance with the embodiment of FIG. 1B without the sliding fence assembly 20 to better show the elements of the tool plate 52. The tool plate assembly 50 comprises an outside anti-chip tool plate 56 and an inside anti-chip tool plate 57 which provide coplanar plate workpiece support surfaces 54 and are spaced apart a predetermined distance. The outside anti-chip tool plate 56 and the inside anti-chip tool plate 57 define a tool gap 51 through which the saw blade 106, may extend. By supporting a workpiece 110 adjacent both sides of the saw blade 106, such as shown in FIG. 2B, reduces the likelihood of chipping and splintering of the workpiece 110 during the cut. Either or both of the outside anti-chip tool plate 56 and the inside anti-chip tool plate 57 may be adjustable with respect to the extension arm sliding support 42 and themselves, such that the width of the tool gap 51 may be predetermined for a particular purpose; in other words, they are adjustable. Such adjustability provides a means to, among other things, but not limited thereto, accommodate various locations and thicknesses of the saw blade 106.

In accordance with an embodiment, the tool gap 51 may be adjusted in width so as to closely correspond to the width of the saw blade 106 so as to support the workpiece 110 to prevent splintering and chipping of the workpiece 110 during cutting. The tool plate 52 further defines a plate workpiece support surface 54 that is operable to rest on the workpiece 110.

It is understood and appreciated that in accordance with another embodiment, there is one tool plate 52 wherein the tool gap 51 may be made in the one tool plate 52 by plunging the saw blade 106 through the tool plate 52. This provides a close fit between the saw blade 106 and the tool plate 52 for a particular saw blade, although at a loss of adjustability as provided by the previous embodiment.

Referring to FIG. 1B, the outside anti-chip tool plate 56 and the inside anti-chip tool plate 57 define a blade guard aperture 60 through which a blade guard 108, such as, by way of example but not limited thereto, a circular saw blade guard 108, may extend therethrough before and after the cut is made.

Each of the extension arm sliding supports 42 are coupled to the tool plate 52 at the tool plate first end 53 and the tool plate second end 55, respectively.

The lateral extension arms are elongated members having a lateral extension arm first end 44 and a lateral extension arm second end 45 opposite the lateral extension arm first end 44. The extension arm sliding supports 42 are operable to slidingly receive and engage the lateral extension arms 40 so as to translate the extension arm sliding supports 42 along a lateral axis Y that is perpendicular to the longitudinal axis X. The extension arm sliding supports 42 of the tool plate assembly 50 are operable to slidingly receive and engage the lateral extension arms 40 along at least a portion of the length of the lateral extension arms 40. Discussion of the extension arm sliding supports 42 is provided below.

The sliding fence assembly 20 comprises the support beam 30 and the fence 29. The fence 29 is operable to slidingly engage the support beam 30. The support beam 30 is an elongated member having a support beam first end 32 and a support beam second end 33 opposite the support beam first end 32. The lateral extension arm first ends 44 of the two lateral extension arms 40 are coupled about the support beam first end 32 and the support beam second end 33, respectively, so as to extend the lateral extension arms 40 along a lateral axis Y that is perpendicular to the longitudinal axis X. The lateral extension arms 40 are operable to support the support beam 30, and thus the fence 29, a predetermined and adjustable distance from the saw blade 106 and substantially parallel with the longitudinal axis X. The interconnection of the of the tool plate 52, the two lateral extension arms 40, and the support beam 30 provide a relatively rigid frame assembly.

The fence 29 is an elongated member having a fence first end 22 and a fence second end 24 opposite the fence first end 22. The fence 29 defines a support beam receiving channel 34 that is operable to slidingly receive and engage the support beam 30.

The fence 29 defines a fence bearing surface 25, a portion of which extends below a plane defined by a workpiece top surface 116 such that is may contact the workpiece edge 112 as shown in FIG. 2B. When the tool plate 52 is placed on and supported by the workpiece 110, the fence bearing surface 25 is operable to slidingly engage a workpiece edge 112. The universal sliding edge guide 10 is operable to guide the circular saw 100 across the workpiece 110, such as, but not limited to, a plywood sheet, relative to the workpiece edge 112, guided by the engagement of the fence bearing surface 25 with the workpiece edge 112.

FIG. 1A shows the fence 29 has been slidingly positioned on the support beam 30 such that the fence first end 22 is adjacent the support beam first end 32, and the fence second end 24 extends away from the support beam second end 33. FIG. 1C is a top perspective view of the universal sliding edge guide 10 wherein the fence 29 has been slidingly positioned on the support beam 30 such that the support beam 30 is substantially adjacent a fence center portion 26 with the fence first end 22 and the fence second end 24 extending substantially the same distance from the support beam first end 32 and the support beam second end 33, respectively. FIG. 1D is a top perspective view of the universal sliding edge guide 10 wherein the fence 29 has been positioned such that the fence first end 22 extends away from the support beam first end 32 and the fence second end 24 is adjacent the support beam second end 33. FIGS. 1A, 1C, 1D illustrate that the fence 29 may be advanced along the support beam 30 to position the fence 29 to stay in contact with the workpiece edge 112 for as long a possible during the cutting operation as will be discussed below.

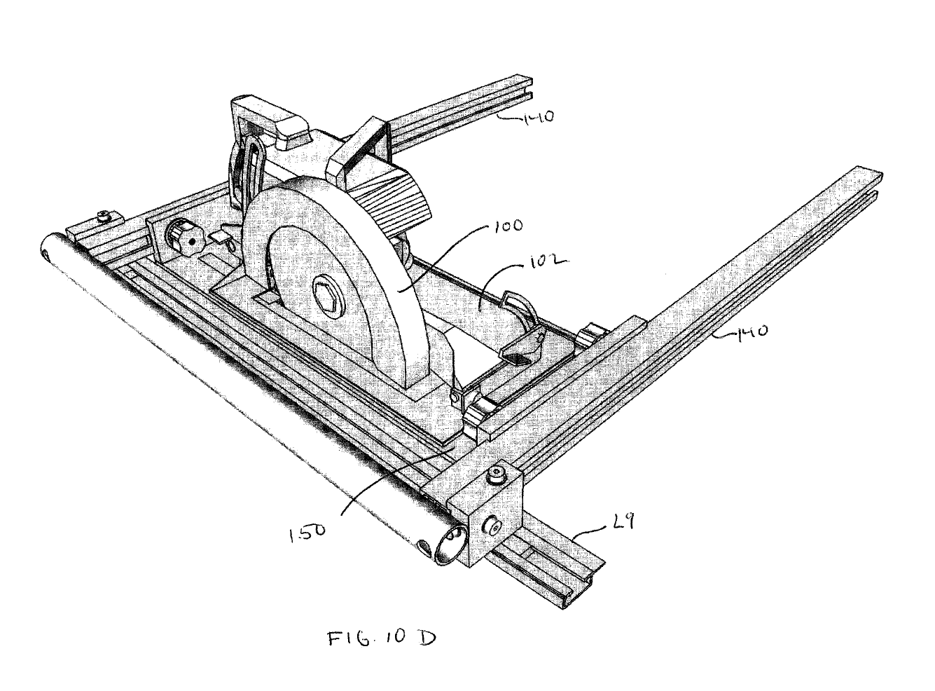

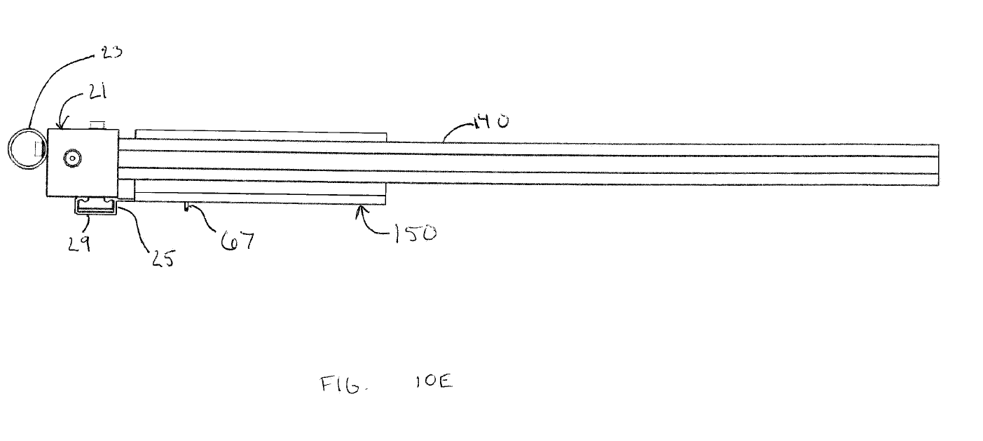

FIGS. 2A-2C are top perspective views of the universal sliding edge guide 10 showing an embodiment of a method of cutting a workpiece 110 using, by way of example, but not limited thereto, a circular saw 100 coupled to the tool plate 52, showing the operation of the sliding fence assembly 20, in accordance with an embodiment. FIG. 2A shows the universal sliding edge guide 10 positioned at the workpiece leading end 113 with a portion of the fence 29 extending forward of the support beam 30 such that at least a portion of the fence bearing surface 25 is placed in contact with the workpiece edge 112 but the saw blade 106 is not engaged with the workpiece 110. The universal sliding edge guide 10 may be held steady and the tool guided accurately relative to the workpiece edge 112 to begin the cutting operation. FIG. 2B shows the universal sliding edge guide 10 and the circular saw 106 coupled thereto having been moved into the workpiece 110 to cut the workpiece 110. With the universal sliding edge guide 10 and the circular saw 106 coupled thereto having been positioned between the workpiece leading end 113 and the workpiece trailing end 114, the fence 29 has moved along the support beam 30 with the fence positioned such that the support beam 30 is substantially adjacent a fence center portion 26 with the fence first end 22 and the fence second end 24 extending substantially the same distance from the support beam first end 32 and the support beam second end 33, respectively. While the power tool engages the workpiece 110, the power tool, as coupled to the universal sliding edge guide 10, and the fence are held in relative position taking advantage of the balance and control offered by being able to utilize a substantial portion of the fence bearing surface 25 against the workpiece edge 112. In accordance with an embodiment, the circular saw 100 may be advanced along the workpiece 110 with one hand and the fence 29 advanced along the workpiece 110 with the other hand to substantially maintain the relative position therebetween. A handle may be coupled to the fence 29 to provide a handhold for controlling the movement of the fence 29, similar to handle 23 shown in FIG. 10A.

In accordance with another embodiment, one or more fence stays 28 may be provided that are operable to hold fast the fence 29 relative to the support beam 30. The fence stay 28 may be engaged to prevent relative movement between the fence 29 and the support beam 30 at any time during the workpiece 110 cutting.

FIG. 2C shows the universal sliding edge guide 10 positioned at the workpiece trailing end 114 wherein the circular saw 100 has made the cut in the workpiece 110 with a portion of the fence 29 comprising the fence first end 22 extending beyond the support beam first end 32. The fence 29 has been positioned such that the fence first end 22 extends away from the support beam first end 32 and the fence second end 24 is adjacent the support beam second end 33, such that at least a portion of the fence bearing surface 25 remains engaged with the workpiece edge 112 as the saw blade 106 advances and becomes disengaged from the workpiece 110 at the workpiece trailing end 114.

FIG. 2A illustrates that, at the beginning of the cutting operation, the universal sliding edge guide 10, and thus the circular saw 106 coupled thereto, is well supported to stay in alignment with the workpiece edge 112 by providing a significant portion of the fence bearing surface 25 being engaged with the workpiece edge 112 at the workpiece leading end 113. FIG. 2C illustrates that, at the end of the cutting operation, the universal sliding edge guide 10, and thus the circular saw 106 coupled thereto, is well supported to stay in alignment with the workpiece edge 112 by a significant portion of the fence bearing surface 25 being engaged with the workpiece edge 112 at the workpiece trailing end 114. The fence 29 having the ability to slide along a substantial length of the support beam 30 allows that the overall length of the fence 29 may be reduced as compared with a stationary fence that is sized in length to provide the same amount of fence bearing surface 25 at the beginning and end of the cutting operation, lending to the portability of the universal sliding edge guide 10.

The universal sliding edge guide 10 is operable to provide tool guidance by way of the sliding fence assembly 20 providing a fence 29 in which a significant portion of the fence 29 is operable to engage the workpiece edge 112 of the workpiece 110 at the beginning of the operation before the tool engages the workpiece 110, during the tool engagement, and after the operation where the tool disengages the workpiece 110 while a portion of the sliding fence 20 remains engaged with the workpiece edge 112. This tool guidance provides, among other things, accurate and straight cuts relative to the workpiece edge 112.

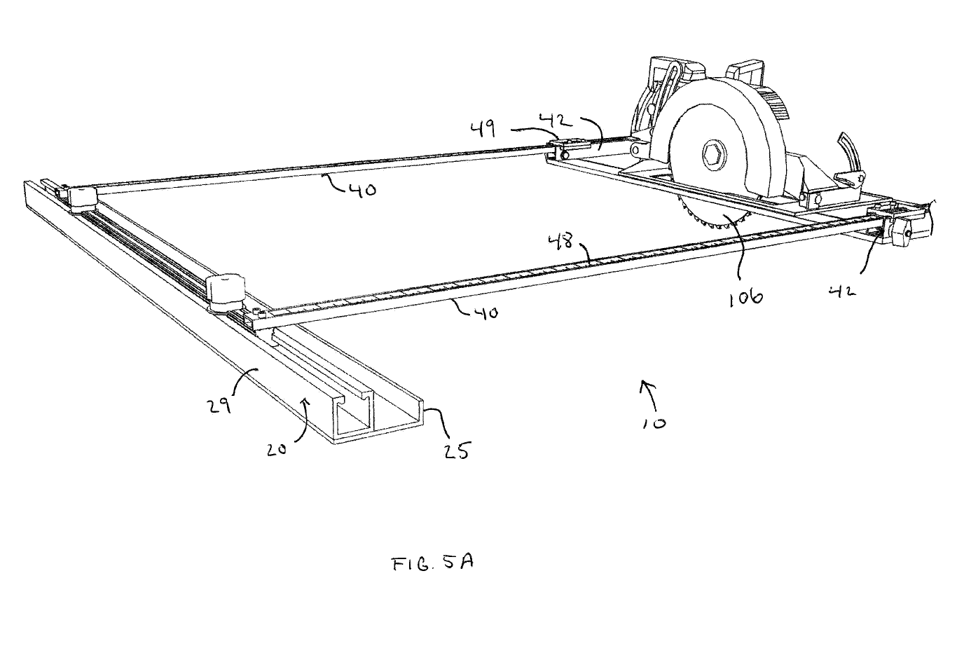

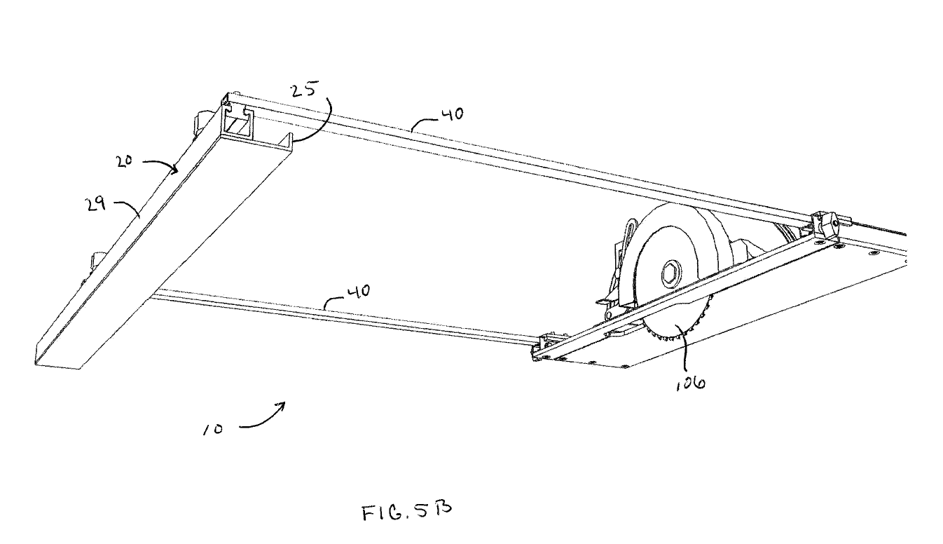

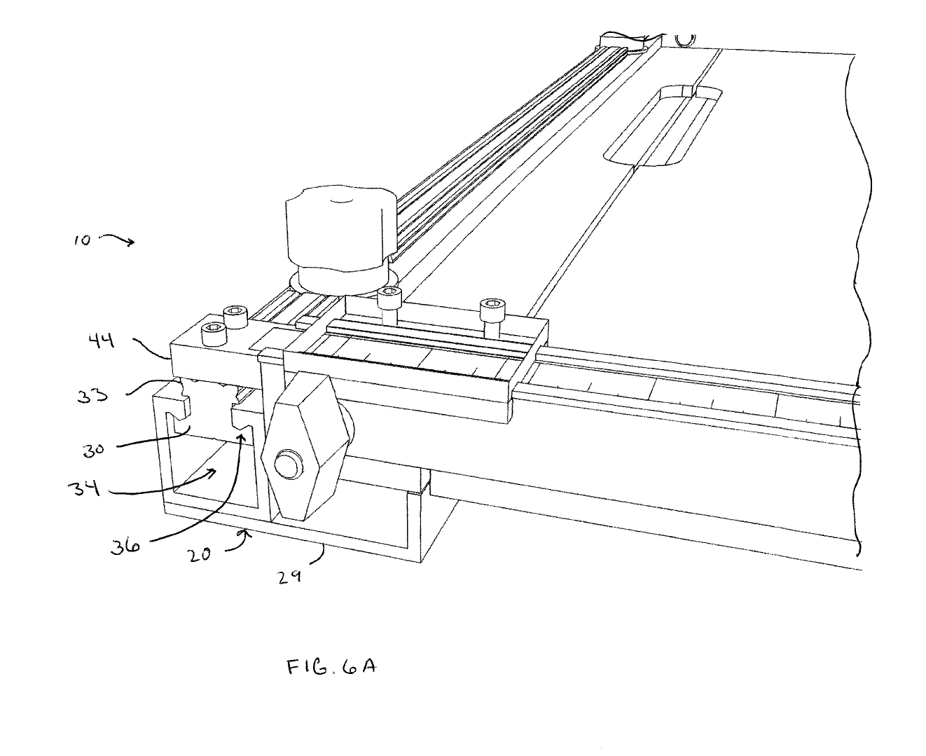

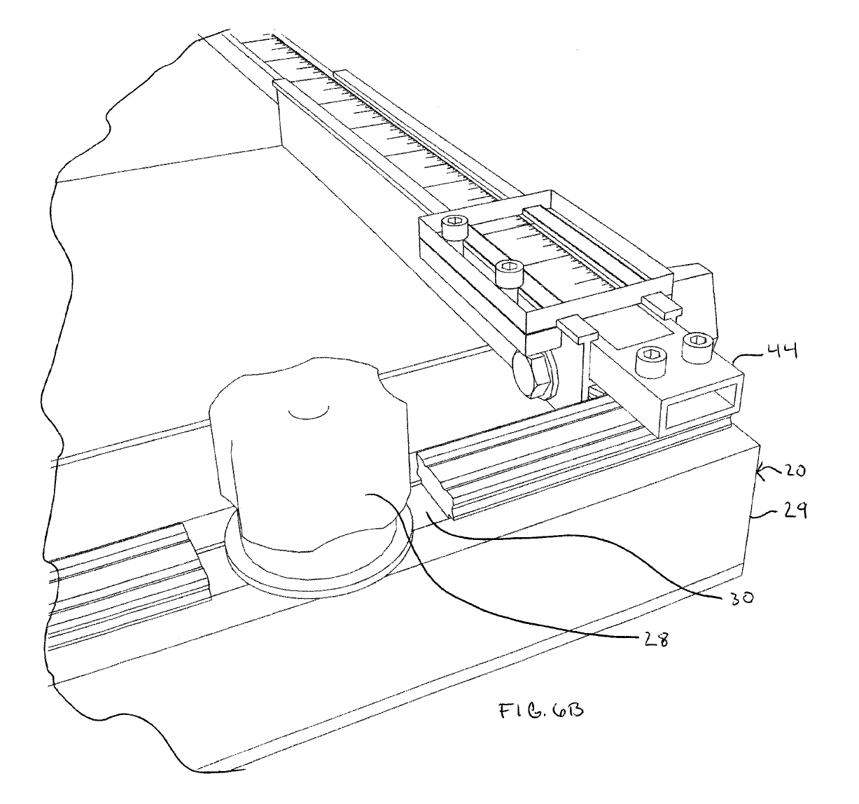

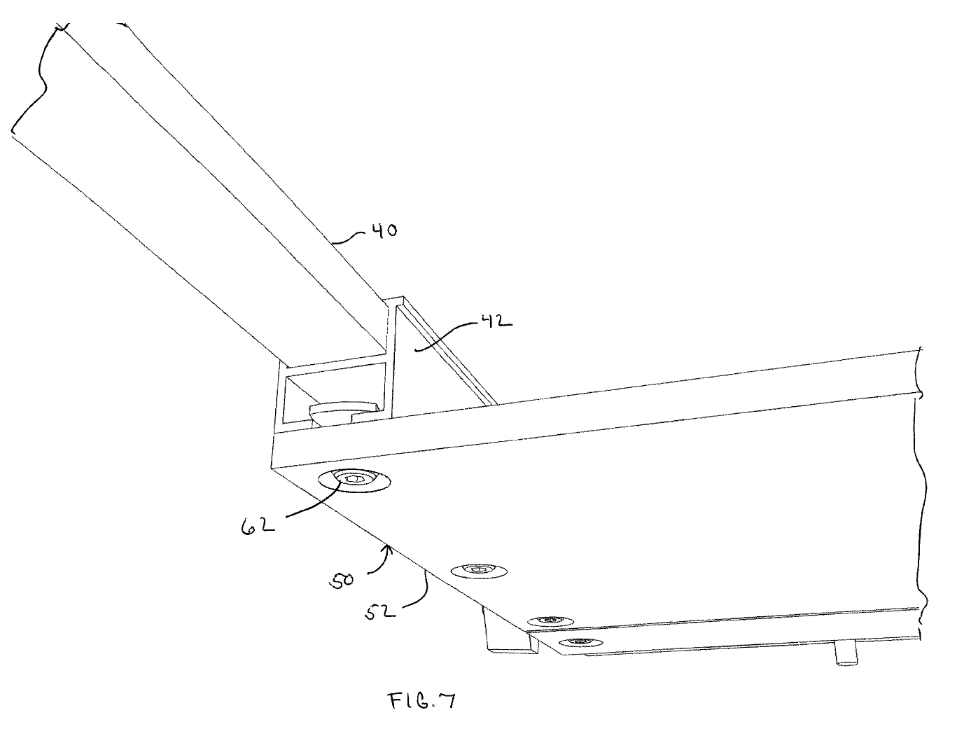

FIGS. 4A-4B and 5A-5B are top and bottom perspective views, respectively, of the universal sliding edge guide 10 in accordance with the embodiment of FIG. 1A. The lateral extension arms 40 and the extension arm sliding supports 42 are operable for sliding engagement therebetween. The sliding engagement between the lateral extension arms 40 and the extension arm sliding supports 42 is operable to provide a means for establishing a predetermined distance D between the saw blade 106 and the fence bearing surface 25, and thus establishing the width of the cut workpiece. The predetermined distance may be adjusted across a range of distance, the maximum distance determined in part by the length of the lateral extension arms 40. The workpiece may be repeatably cut into portions having the same width without further measuring or adjustment of the extension arm sliding supports 42 along the lateral extension arms 40, with the fence bearing surface 25 engaging the workpiece edge created from the previous cutting operation.

In accordance with an embodiment, the lateral extension arms 40 further comprise a graduated scale 48 operable to indicate, such as, but not limited to, the distance between the saw blade 106 and the fence bearing surface 25. Scale pointers 49 are disposed above the graduated scale 48 to indicate the position of the saw blade 106 relative to the fence bearing surface 25. One method of operation is that the desired width of a cut of sheet stock may be set by adjusting the extension arm sliding support 42 to a desired measurement on the graduated scale 49, rather than measuring and marking the workpiece 110.

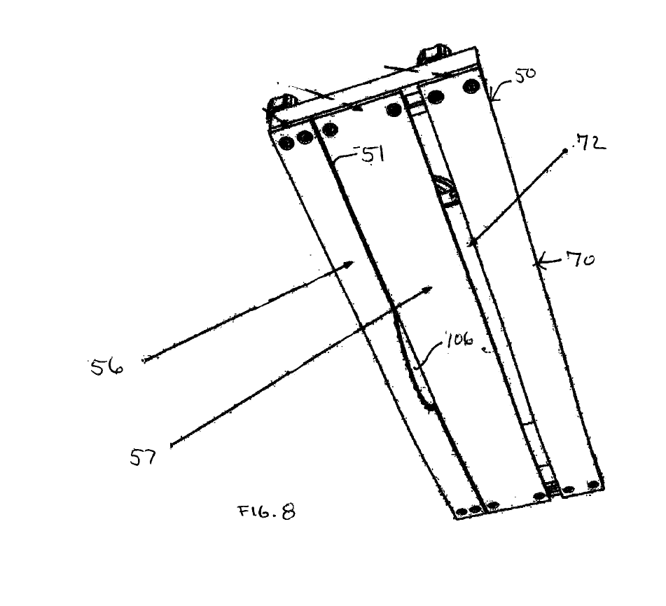

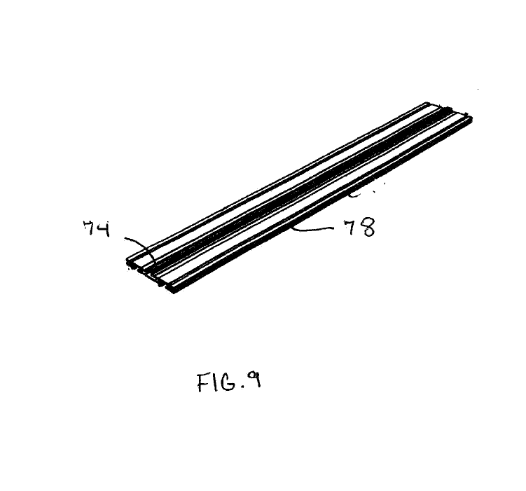

FIGS. 6A-B are front and side perspective views, respectively, of a corner of the universal sliding edge guide 10, in accordance with an embodiment. In FIG. 6A, the lateral extension arm first end 44 is coupled to the support beam second end 33. The fence 29 defines a support beam receiving channel 34 operable to accept at least a portion of the support beam 30. The fence 29 is slidingly received onto the support beam 30 via the support beam receiving channel 34.

In FIG. 6B, the fence stay 28 is operable to engage the support beam 30 and the fence 29 so as to temporarily prevent movement therebetween. In accordance with the embodiment of FIG. 6B, the fence stay 28 draws the support beam 30 against the sliding fence 20 bringing into pressing engagement alignment elements 36 defined thereby as shown in FIG. 6A. The alignment elements 36 are operable to coaxially align the fence 29 with the support beam 30.

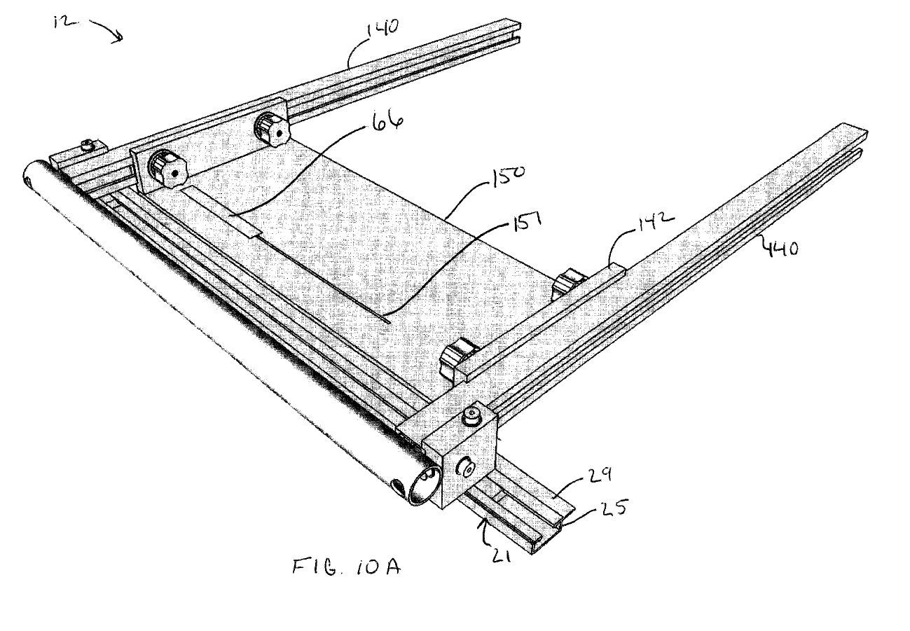

FIG. 7 is a perspective view of an embodiment of the extension arm sliding support 42 and the lateral extension arm 40. The extension arm sliding support 42 defines an extension arm receiving channel 46 operable to slidingly receive the lateral extension arm 40 therein. A tool plate fastener 62 is operable to couple the tool plate 52 to the extension arm sliding support 42 to define the tool plate assembly 50.

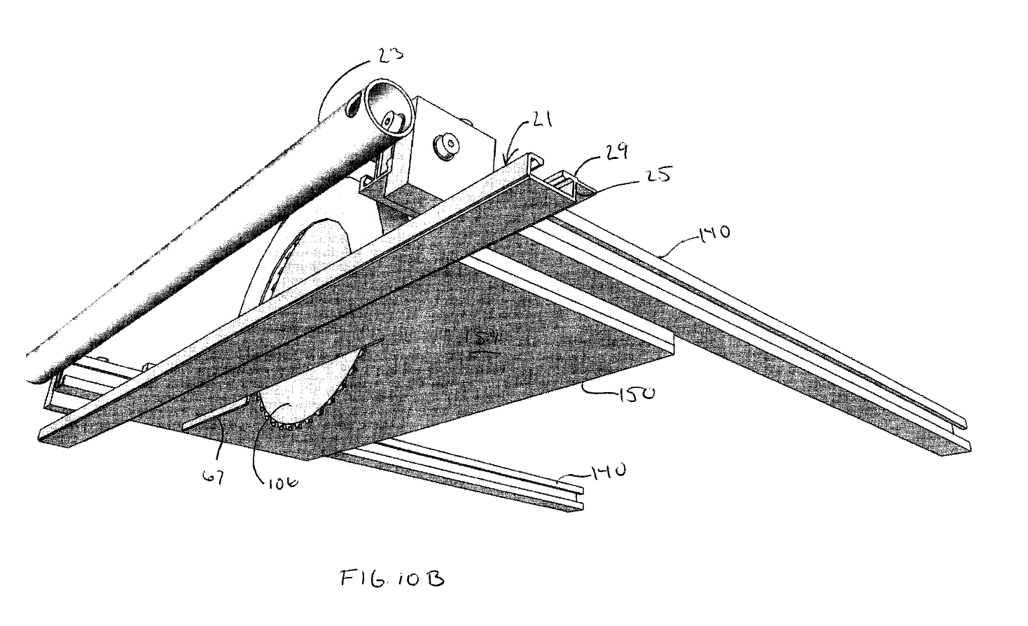

FIG. 8 is a bottom perspective view of a tool plate assembly 50 in accordance with another embodiment. The tool plate assembly 50 comprises an outside anti-chip tool plate 56, an inside anti-chip tool plate 57, and a track guide tool plate 70. The outside anti-chip tool plate 56 and the inside anti-chip tool plate 57 define a tool gap 51 through which a saw blade 106 may extend. Either or both of the outside anti-chip tool plate 56 and the inside anti-chip tool plate 57 may be adjustable such that the width of the tool gap 51 may be adjustable. Such adjustability provides a means to accommodate various locations and thicknesses of the saw blade 106.

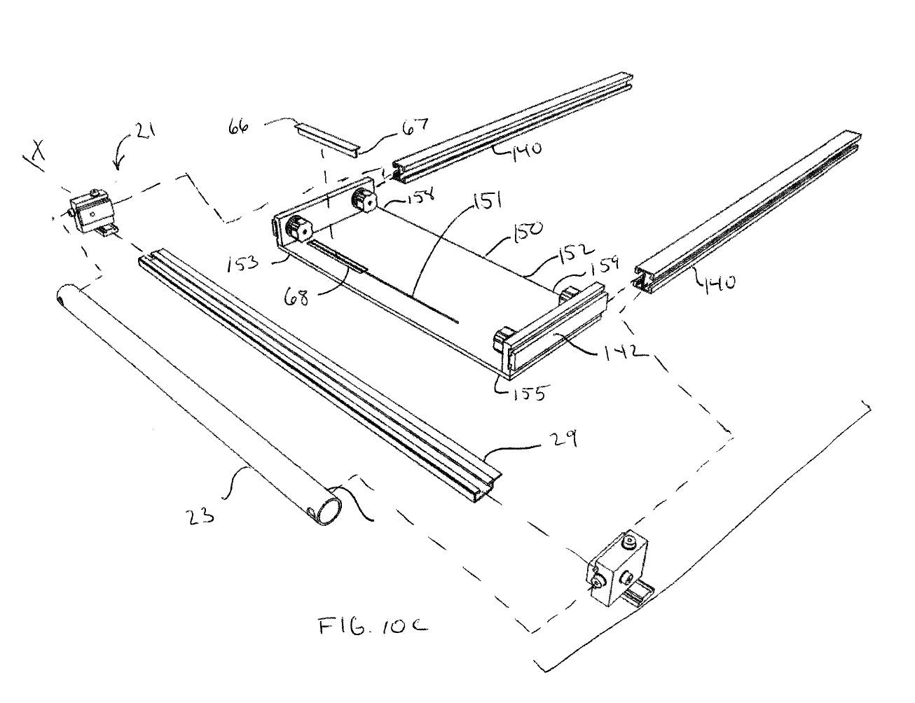

A track guide tool plate 70 is positioned adjacent to and spaced apart from the inside anti-chip tool plate 57. The track guide tool plate 70 and the inside anti-chip tool plate 57 define a track guide gap 72 that is operable to slidingly receive and cooperate with a track 74 of a system comprising a guide rail 78, as shown in FIG. 9, and as provided, for example, but not limited to, the guide plate of U.S. Pat. No. 7,621,206. Adjustability of the width of the track guide gap 72 allows for use with the various commercially available track saw and guide rail systems.

As previously discussed, the sliding fence assembly 20 may be provided with one or more fence stays 28 operable to prevent the movement of the fence 29 relative to the support beam 30. Embodiments of a universal edge guide wherein the sliding fence assembly 20 of the embodiment of FIG. 1A is replaced by a stationary fence. FIGS. 10A-E are top, bottom, exploded, and assembled with a circular saw perspective views and a front view, respectively, of a universal edge guide 12 in accordance with an embodiment. The universal edge guide 12 comprises a tool plate assembly 150, a pair of lateral extension arms 140, and a stationary fence assembly 21. The stationary fence assembly 21 is coupled to the lateral extension arms 140 in substantially the same way as the support beam 30 is coupled to the lateral extension arms 40 of the embodiment of FIG. 1A. In other words, the stationary fence 21 is coupled in non-slidable engagement with the lateral extension arms 40. It is appreciated that there are many ways to couple the various elements together to provide the form and features as described, and the examples provided herein are not to be limited thereto.

The extension arm sliding supports 142 of the tool plate assembly 150 are operable to slidingly receive and engage the lateral extension arms 140 along at least a portion of the length of the lateral extension arms 140 and function substantially similar to the extension arm sliding supports 42 and the lateral extension arms 40 of the embodiment FIG. 1A. The embodiment of FIGS. 10A-E shows alternative elements for coupling the extension arm sliding supports 142 to the lateral extension arms 140.

The tool plate assembly 150 is substantially the same as for the tool plate assembly 50 of the embodiment of FIG. 1A but showing alternative elements for coupling the tool plate assembly 150 together. The tool plate assembly 150 is an elongated member comprising a tool plate assembly first end 158 and a tool plate assembly second end 159 opposite the tool plate assembly first end 158. The tool plate assembly 150 is operable to couple to and support a tool, such as a circular saw 100, by way of example, but not limited thereto, such that a saw blade 106 may be positioned to cut parallel to the longitudinal axis X.

The tool plate assembly 150 comprises a tool plate 152 and a pair of extension arm sliding supports 142. The tool plate 152 comprises a tool plate first end 153 and a tool plate second end 155 opposite the tool plate first end 153. The tool plate 152 is operable for coupling to a tool base plate 102 of the circular saw 100. In accordance with an embodiment, a tool base plate 102 is coupled to the tool plate 152. The coupling of the tool base plate 102 may be, for example, by way of adhesive and mechanical fasteners, among others.

The tool plate 152 is operable to accommodate the working portion of the power tool therethrough, in this embodiment, the saw blade 106. FIG. 10B is a bottom perspective view of the tool plate assembly 150 in accordance with an embodiment. The tool plate assembly 150 comprises a tool gap 151 that is parallel to the fence bearing surface 25 and the longitudinal axis X and is operable to accommodate the saw blade 106 therethrough.

In accordance with an embodiment, the tool plate assembly 150 further comprises a secondary guide insert 66 and a secondary guide aperture 68. The secondary guide insert 66 comprises a secondary guide fin 67. The secondary guide aperture 68 is operable to receive the secondary guide insert 66 such that the secondary guide fin 67 extends through the tool gap 151, or through a slot aligned with the tool gap 151, and extends beyond a plane defined by a tool plate workpiece support surface 154 of the tool plate 52. The secondary guide fin 67 is operable to follow behind the saw blade 106 in the kerf during a cutting operation and abut and slide along a newly cut workpiece edge in the kerf formed by the saw blade 106. The secondary guide fin 67 substantially prevents any tendency for the kerf to close up or narrow which may cause binding on the saw blade 106, may cause the fence bearing surface 25 to partially disengage a portion of the workpiece edge (see 112 of FIG. 2B) and thus cause an off-parallel cut, among other things.

In accordance with an embodiment, a plurality of secondary guide inserts 66 are provided, each having a secondary guide fin 67 having one of a plurality of predetermined thicknesses corresponding to a kerf of a particular saw blade 106. The secondary guide inserts 66 may be interchanged in the tool plate 52 to correspond to a change in saw blade kerf.

In accordance with another embodiment, a plurality of parallel spaced apart slots (not shown), parallel with the tool gap 151 is provided in the secondary guide aperture 68 in the tool plate 52. The slots are operable to accept the secondary guide fin 67 therethrough. The secondary guide fin 67 of a secondary guide insert 66 may be moved from one slot to another slot that corresponds to one side of a kerf produced by a particular saw blade 106. The secondary guide inserts 66 may be interchanged in a corresponding slot to correspond to a change in thickness of a kerf made by a particular saw blade.

It is appreciated that the tool plate 152 comprising the secondary guide insert 66 may also be used in the embodiments of the universal sliding edge guide 10 of the embodiments of FIG. 1A.

It is also appreciated that the secondary guide insert 66 may be incorporated in substantially similar arrangement in a tool base plate of a tool, such that when the tool is not coupled to the universal edge guide 10 or universal sliding edge guide 12, the benefit of additional support and guidance provided by the secondary guide fin 67 in the kerf may be realized.

It is also appreciated that an element substantially similar to the secondary guide fin 67 may be formed as an integral part of a tool base plate or as an integral part of the tool plate 52, 152.

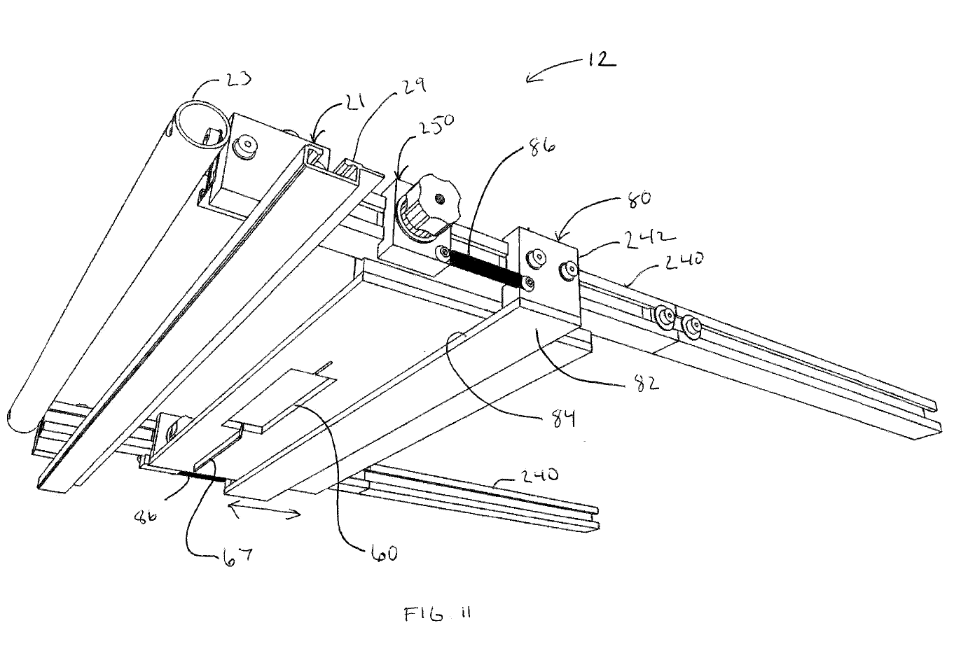

FIG. 11 is a bottom perspective view of an embodiment of a pusher bar assembly 80 as provided on the embodiment of the universal edge guide 12 of FIG. 10A by way of example. It is appreciated that the pusher bar assembly 18 may be used with any of the embodiments presented herein. The pusher bar assembly 80 is an elongated member comprising a pusher bar 82 and a pair of extension arm sliding supports 242. The extension arm sliding supports 242 are operable to slidingly receive and engage the lateral extension arms 240 along at least a portion of the length of the lateral extension arms 240. The pusher bar assembly 250 is coupled to the tool plate assembly 250 by springs 86. The springs 86 are operable to provide a bias towards the fence 29. The pusher bar 82 comprises a pusher bar bearing surface 84 that is used to engage a workpiece along a side opposite that of the workpiece edge 112 as shown in FIG. 2A. The pusher bar 82 is operable to provide a bias force against an opposite edge of the working piece 100 so as to bias the working piece 100 against the fence 29. The pusher bar 82 is advanced on the lateral extension arms 240 in a direction away from the fence 29 with the working piece placed between the fence 29 and the pusher bar 82 bearing surface 84. The pusher bar 82 enables the workpiece to remain engaged with the fence 29 and/or the secondary guide fin 67 before, during and after the cutting operation.

While the invention has been described in connection with specific embodiments thereof, it will be understood that it is capable of further modification, and this application is intended to cover any variations, uses, or adaptations of the invention following, in general, the principles of the invention and including such departures from the present disclosure as come within known or customary practice in the art to which the invention pertains and as may be applied to the essential features hereinbefore set forth, and as fall within the scope of the invention and the limits of the appended claims.

I claim:

1. A universal edge guide for guiding a tool, comprising:
a tool plate assembly operable to couple with the tool, the tool plate assembly being operable to accommodate a working portion of the tool therethrough;
a pair of lateral extension arms coupled in sliding engagement with the tool plate assembly; and
a fence assembly coupled to the pair of lateral extension arms.

2. The universal edge guide of claim 1, wherein the lateral extension arms define a lateral axis and wherein the fence defines a longitudinal axis perpendicular to the lateral axis, wherein the fence assembly is operable to translate relative to the pair of lateral extension arms along the longitudinal axis.

3. The universal edge guide of claim 2, wherein the fence assembly includes a sliding fence assembly comprising:
a support beam coupled to the lateral extension arms; and
a fence coupled in sliding engagement with the support beam, operable such that the fence may slide along a significant portion of a length of the support beam.

4. The universal edge guide of claim 3, wherein the tool plate assembly comprises a tool plate assembly first end and a tool plate assembly second end opposite the tool plate assembly first end, the tool plate assembly is operable to couple with and support the tool such that the tool may be positioned to process a workpiece parallel to the longitudinal axis.

5. The universal edge guide of claim 1, wherein the tool plate assembly comprises:
a tool plate including a tool plate first end and a tool plate second end opposite the tool plate first end, the tool plate being operable to accommodate a working portion of the tool therethrough; and
a pair of extension arm sliding supports each coupled to one of the tool plate first end and the tool plate second end, the sliding supports in sliding engagement with the lateral extension arms.

6. The universal edge guide of claim 5, wherein the tool plate assembly comprises:
an outside anti-chip tool plate; and
an inside anti-chip tool plate, the outside anti-chip and the inside anti-chip tool plate tool plate provide coplanar plate workpiece support surfaces and are spaced apart a predetermined distance, wherein the outside anti-chip tool plate and the inside anti-chip tool plate define a tool gap the working portion of the tool may extend.

7. The universal edge guide of claim 5, wherein the lateral extension arms are elongated members having a lateral extension arm first end and a lateral extension arm second end opposite the lateral extension arm first end, the extension arm sliding supports are operable to slidingly receive and engage the lateral extension arms so as to translate the extension arm sliding supports along the lateral axis.

8. The universal edge guide of claim 7, wherein the extension arm sliding supports of the tool plate assembly are operable to slidingly receive and engage the lateral extension arms along at least a portion of a length of the lateral extension arms.

9. The universal edge guide of claim 8, wherein the fence assembly comprises:
a support beam, the support beam is an elongated member having a support beam first end and a support beam second end opposite the support beam first end; and
the fence, the fence being operable to slidingly engage the support beam,
the lateral extension arm first ends of the two lateral extension arms are coupled about the support beam first end and the support beam second end, respectively, so as to extend the lateral extension arms along the lateral axis,
the lateral extension arms are operable to support the support beam, and thus the fence, a predetermined and adjustable distance from the working portion of the tool and substantially parallel with the longitudinal axis,
the fence is an elongated member having a fence first end and a fence second end opposite the fence first end, the fence defines a support beam receiving channel that is operable to slidingly receive and engage the support beam therein, the fence defines a fence bearing surface, a portion of which extends below a plane defined by a workpiece top surface operable such that is may contact a workpiece edge when the tool plate is placed on and supported by the workpiece, the fence bearing surface is operable to slidingly engage the workpiece edge, the universal sliding edge guide is operable to guide the tool across the workpiece relative to the workpiece edge guided by the engagement of the fence bearing surface with the workpiece edge.

10. The universal edge guide of claim 9, further comprising one or more fence stays being operable to hold fast the fence relative to the support beam, the fence stay operable to allow or prevent relative movement between the fence and the support beam.

11. The universal edge guide of claim 10, wherein the lateral extension arms and the extension arm sliding supports are operable for sliding engagement therebetween, the sliding engagement between the lateral extension arms and the extension arm sliding supports is operable to provide a means for establishing a predetermined distance between the working portion of the tool and a fence bearing surface.

12. The universal edge guide of claim 11, further comprising the lateral extension arms further comprise a graduated scale operable to indicate the distance between the working portion of the tool and the fence bearing surface, scale pointers are disposed above the graduated scale to indicate the position of the working portion of the tool relative to the fence bearing surface.

13. The universal edge guide of claim 12, further comprising a fence stay being operable to engage the support beam and the fence so as to prevent movement therebetween.

14. The universal edge guide of claim 11, wherein the tool plate assembly comprises an outside anti-chip tool plate, an inside anti-chip tool plate, and a track guide tool plate, the outside anti-chip tool plate and the inside anti-chip tool plate define a tool gap through which a saw blade may extend.

15. The universal edge guide of claim 14, further comprising a track guide tool plate positioned adjacent to and spaced apart from the inside anti-chip tool plate, the track guide tool plate and the inside anti-chip tool plate define a track guide gap being operable to slidingly receive and cooperate with a track of a guide rail system.

16. The universal edge guide of claim 5, further comprising:
the tool plate assembly further comprising a secondary guide insert and a secondary guide aperture, the secondary guide insert comprising a secondary guide fin, the secondary guide aperture is operable to receive the secondary guide insert such that the secondary guide fin extends through a slot aligned with a tool gap and extends beyond a plane defined by a tool plate workpiece support surface of the tool plate, the secondary guide fin is operable to follow behind the working portion of the tool in the kerf and abut and slide along a cut workpiece edge in the kerf formed by the working portion of the tool.

17. The universal edge guide of claim 16, further comprising a plurality of secondary guide inserts, each having a secondary guide fin having one of a plurality of predetermined thicknesses corresponding to a kerf of a particular working portion of the tool, the secondary guide inserts may be interchanged in the tool plate to correspond to a change in working portion of the tool kerf.

18. The universal edge guide of claim 16, further comprising a plurality of parallel spaced apart slots parallel with the tool gap provided in the secondary guide aperture in the tool plate, the slots being operable to accept the secondary guide fin therethrough, the secondary guide fin of a secondary guide insert may be moved from one slot to another slot that corresponds to one side of a kerf produced by a particular working portion of the tool.

19. The universal edge guide of claim 16, further comprising a pusher bar assembly, the pusher bar assembly including a pusher bar and a pair of extension arm sliding supports, the extension arm sliding supports are operable to slidingly receive and engage the lateral extension arms along at least a portion of a length of the lateral extension arms, the pusher bar assembly is coupled to the tool plate assembly by resilient members operable to provide a bias towards the fence, the pusher bar comprises a pusher bar bearing surface that is operable to engage a workpiece along a side opposite that of the workpiece edge, the pusher bar being operable to provide a bias force against an opposite edge of a working piece so as to bias the working piece against the fence, the pusher bar being operable to be advanced on the lateral extension arms in a direction away from the fence.

20. Apparatus with the inventive features shown and described.

21. Methods with the inventive features shown and described.
